(19) United States
(12) Patent Application Publication
(10) Pub. No.: US 2026/0338228 A1
(43) Pub. Date: Oct. 29, 2026

(54) Bearing device with incorporated electrical insulation

(71) Applicant: AKTIEBOLAGET SKF, GOTEBORG (SE)

(72) Inventors: Benoit ARNAULT, Saint-Cyr-sur-Loire (FR); Mickael CHOLLET, Jour-Les-Tours (FR)

(21) Appl. No.: 19/654,175

(22) Filed: Apr. 21, 2026

(30) Foreign Application Priority Data
Apr. 24, 2025 (FR) FR2504338

(51) Int. Cl. F16C 19/52; F16C 19/06; F16C 33/64

(52) U.S. Cl. CPC F16C 19/52; F16C 19/06; F16C 33/64; F16C 2202/30; F16C 2220/06; F16C 2240/60; F16C 2380/26

(57) ABSTRACT

A bearing device includes a bearing having a first ring and a second ring configured for relative rotation, and an insulation sleeve mounted on the second ring. The insulation sleeve includes a bushing and an electrically insulating lining interposed radially between the bushing and the second ring. The insulating lining is overmolded on the second ring and the bushing, and at least one groove is provided on a surface of the bushing that faces away from the insulating liner. A resiliently deformable retainer ring is mounted in the groove such that a portion of the retainer ring projects from the groove radially beyond a surface of the bushing.

### CROSS-REFERENCE

This application claims priority to French patent application no. 2504338 filed on Apr. 24, 2025, the contents of which are fully incorporated herein by reference.

### TECHNOLOGICAL FIELD

The present disclosure concerns the field of bearings used in particular in electric motors, electrical machines, and associated equipment.

### BACKGROUND

In an electric motor or an electrical machine, at least one roller bearing is fitted between the housing of the electric motor or electrical machine and a rotary shaft in order to support the shaft. In operation, when the shaft is rotating, a difference of electrical potential can appear between the shaft and the housing of the electric motor or the electrical machine, and this generates an electric current between the inner ring of the roller bearing, which is integral with the shaft, and the outer ring, which is integral with the housing. The electric current which passes through the components of the roller bearing can damage its components, in particular the rolling elements and the raceways provided on the inner and outer rings. The electrical discharges can also generate vibrations.

In order to eliminate these disadvantages, it is known to equip the outer ring of the roller bearing with an insulation sleeve that comprises a bushing and an insulating lining which is produced from electrically insulating material, and is interposed radially between the outer ring and the bushing. In operation, when the shaft is rotating, the bushing of the insulation sleeve, which is in contact with the housing, must be secured angularly in relation to the housing, and the inner ring of the bearing in contact with the shaft must be secured angularly in relation to the shaft. For this purpose, the bearing is generally fitted clamped between the housing of the electric motor or electrical machine and the rotary shaft.

The bearing, which may be formed from different materials than the housing and the shaft, can have thermal expansion properties which are different from those of the housing and the shaft. Thus, when the temperature of the electric motor or the electrical machine increases, phenomena of creeping appear, in particular when the bearing is clamped excessively tightly between the housing of the electric motor or the electrical machine and the rotary shaft.

In order to eliminate these disadvantages, it is known to fit the bearing device with a radial gap between the bushing of the insulation sleeve and the housing of the electric motor or of the electrical machine. This solution is suitable when the bearing is configured to withstand small axial and/or radial loads. However, when the axial and/or radial loads experienced by the bearing are too great, the insulation sleeve and the outer ring of the bearing turn relative to the housing of the electric motor or the electrical machine.

### SUMMARY

An aspect of the present disclosure is thus to eliminate the aforementioned disadvantages by proposing a bearing device with a simple and economical design.

The present disclosure concerns a bearing device comprising: a bearing having a first ring and a second ring that are configured to rotate relative to one another; and an insulation sleeve which is fitted on the second ring and has a bushing and an insulating lining which is interposed radially between the second ring and the bushing, and is formed from an electrically insulating material, with the bushing having an outer surface and an inner surface opposite the outer surface which delimit a radial thickness of the bushing. The insulating lining is overmolded at least on the second ring of the bearing, and at least on one of the inner and outer surfaces of the bushing which is oriented towards the second ring.

According to a first general characteristic, at least one groove is formed on the other outer or inner surface of the bushing. According to a second general characteristic, the device also comprises at least one retainer ring which is resiliently deformable, which is positioned in the groove, and which projects radially relative to the other outer or inner surface of the bushing.

“Resiliently deformable retainer ring” means a retainer ring which, as a result of the material used and/or its size, can be deformed under the action of an external stress, and tend to regain its initial form by resilience if the stress ceases.

Thus, the bearing can be fitted with a gap between the insulation sleeve fitted on the second ring and the element from between the housing or the shaft which is facing the sleeve, without the insulation sleeve and the second ring turning in relation to the element.

When the bearing is thus fitted, the retainer ring is deformed, and is radially in contact with the element and with a base of the groove. The retainer ring tends to regain its initial, non-deformed form, and thus exert a permanent force which ensures the retention in the circumferential direction of the insulation sleeve and of the second ring, relative to the element, and which also ensures the retention in the axial direction.

In particular, the axial and radial loads which the bearing device fitted with a gap of this type can withstand are thus increased, without the insulation sleeve and the second ring turning relative to the element and without the bearing device being displaced axially, compared with a bearing device of this type without the groove and the retainer ring. In addition, the bearing device has a simple and economical design.

Optionally, a plurality of grooves are formed on the other outer or inner surface of the bushing, with the device comprising a plurality of retainer rings which are resiliently deformable, each retainer ring being positioned in one of the grooves, and extending radially projecting in relation to the other outer or inner surface of the bushing. In this case, the retainer rings can have identical or different radial thicknesses.

Advantageously, the bushing of the insulation sleeve is provided with radial faces which delimit axially the inner and outer surfaces of the bushing, with the retainer ring remaining axially spaced from the radial faces.

Preferably, the radial thickness of the retainer ring is greater than a radial depth of the groove. Advantageously, the axial width of the retainer ring is smaller than the axial width of the groove. Thus, the retainer ring can be resiliently deformed in the axial direction in the interior of the groove.

According to a first embodiment, the groove is annular. Optionally, according to the first embodiment the retainer ring is annular. Alternatively, according to the first embodiment, the retainer ring can extend in the circumferential direction around an angular sector smaller than 360°. According to a second embodiment, the groove extends in the circumferential direction around an annular sector smaller than 360°, with the retainer ring extending in the circumferential direction around an angular section smaller than, or equal to, the angular sector of the groove.

According to one embodiment, the retainer ring is produced from resiliently deformable material. By way of indication, the retainer ring can for example be produced from a synthetic material such as Styrene-Ethylene-Butylene-Styrene (SEBS), or of an elastomer material such as silicone rubber, latex, butyl, EPDM, nitrile, a thermoplastic elastomer, etc.

Alternatively, the retainer ring can be produced from a rigid material, for example a metal material such as steel. In this case, the deformable nature of the retainer ring is obtained by means of its form.

According to a first variant, the bushing of the insulation sleeve is formed as one piece. According to a second, alternative variant, the bushing of the insulation sleeve is produced from at least two distinct parts, which each comprise an axial portion, with the axial portions of the two parts being supported axially against one another and delimiting jointly at least partly the surface of the bushing on which the insulating lining is overmolded.

Optionally, according to the second variant, each of the two parts of the bushing comprises a radial flange which extends radially towards the second ring the axial portion of the part. Advantageously, the insulating lining is also overmolded on an inner face of the radial flange of each of the two parts of the bushing.

The production of the two parts of the bushing with radial flanges makes it possible to obtain good solidarity with the insulating lining. The risk of relative displacements between the insulating lining and the bushing in the axial direction is avoided, in particular during variations of temperatures.

Advantageously, the bushing of the insulation sleeve has two radial frontal faces which delimit the axial length of the bushing. In particular, the radial flange of each of the two parts has one of the two frontal faces.

Advantageously, the radial flange of each of the two parts hsa an inner radial face, which is offset axially towards the interior of the device in relation to the frontal faces of the bushing, with the retainer ring remaining axially spaced from the inner radial faces.

Optionally, the radial flange of at least one of the two parts of the bushing extends radially beyond an outer or inner surface of the second ring on which the insulating lining is overmolded.

With an arrangement of this type, the part of the insulating lining which is situated axially between the second ring and this radial flange of the bushing is not subjected to shearing stresses when substantial axial loads are applied to the device fitted in the interior of the housing of the electric motor or the electrical machine associated with this flange supported against a shoulder of the housing. In fact, in this case, compression stresses are applied on this part of the insulating lining. This increases the reliability of the device.

Advantageously, the radial flange of each of the two parts of the bushing extends radially beyond the outer or inner surface of the second ring on which the insulating lining is overmolded. However, as a variant, it remains possible for at least one of the two radial flanges or both radial flanges to be flush with the outer or inner surface of the second ring or to remain radially recessed.

Advantageously, the two parts of the bushing are symmetrical in relation to a median radial plane of the device. This makes it possible to reduce the production cost of the device.

Optionally, at least one of the two parts of the bushing is produced from a plurality of pieces. In this case, the axial portion of the part can be produced from a plurality of pieces of axial portion which jointly delimit partly the surface of the bushing on which the insulating lining is overmolded.

Optionally, according to the first or second variant, the surface of the bushing on which the insulating lining is overmolded is provided with at least one overmolding groove extending in the circumferential direction, and in the interior of which there extends a rib for fastening of the insulating lining with a complementary form.

Optionally, according to the second variant, each axial portion of the two parts of the bushing is provided with at least one overmolding groove which extends in the circumferential direction, and in the interior of which there extends a rib for fastening of the insulating lining with a complementary form.

The insulating lining can be produced from synthetic material or elastomer material. Thus, it makes it possible to render the device insensitive to temperature variations. The bushing can be produced from metal material. The bushing can thus be easily machined to a predetermined radial tolerance. The bearing can comprise at least one row of rolling elements positioned between raceways of the first and second rings. The rolling elements can be produced from metal material.

According to a first design, the bearing device comprises an outer ring and an inner ring which are configured to rotate relative to one another, with the first ring being the inner ring of the bearing, and the second ring being the outer ring of the bearing. In this case, the insulating lining is overmolded at least on the inner surface of the bushing, the groove being formed on the outer surface of the bushing, the retainer ring delimiting the outer diameter of the device.

According to a second, alternative design, the bearing device comprises an outer ring and an inner ring which are configured to rotate relative to one another, the first ring being the outer ring of the bearing, the second ring being the inner ring of the bearing. In this case, the insulating lining is overmolded at least on the outer surface of the bushing, with the groove being formed on the inner surface of the bushing, the retainer ring delimiting the inner diameter of the device.

The disclosure also concerns an electric motor comprising a housing, a shaft, and at least one bearing device as previously defined, fitted radially between the bore of the housing and the shaft.

The first ring is radially in contact with one from between the bore of the housing and the shaft, with a radial gap remaining between the bushing and the other one from between the bore of the housing and the shaft, the retainer ring being compressed radially between the base of the groove and the other one from between the bore of the housing and the shaft.

Optionally, at least half the radial thickness of the retainer ring is inserted in the groove, when the bearing device is fitted radially between the bore of the housing and the shaft.

The disclosure also concerns a method for production of a bearing device as previously defined, comprising fitting of the bushing or one of the two parts of the bushing at the base of a production mold; putting the second ring into place in the interior of the production mold; optionally, fitting the other one of the two parts of the bushing in the interior of the production mold, such that the two parts are axially supported against one another; overmolding the insulating lining at least on the second ring and at least on the inner or outer surface of the bushing which is oriented towards the second ring; extraction from the mold of the unitary assembly formed by the second ring, the bushing and the insulating lining; assembly with the first ring of the assembly formed by the second ring, the bushing and the insulating lining; and assembly with the retainer ring of the assembly formed by the first ring, the second ring, the bushing and the insulating lining.

### BRIEF DESCRIPTION OF THE DRAWINGS

The present disclosure will be better understood by studying the detailed description of embodiments, taken by way of examples which are in no way limiting, and are illustrated by the appended drawings in which:

FIG. 1 is a half-view in axial cross section of a bearing device according to a first embodiment of the disclosure.

FIG. 2 is a view in axial cross-section of an electric motor comprising the bearing device of FIG. 1.

FIG. 3 is a half-view in axial cross section of a bearing device according to a second embodiment of the disclosure.

FIG. 4 is a flow chart illustrating the method for production of the bearing device of FIGS. 1 or 3.

### DETAILED DESCRIPTION

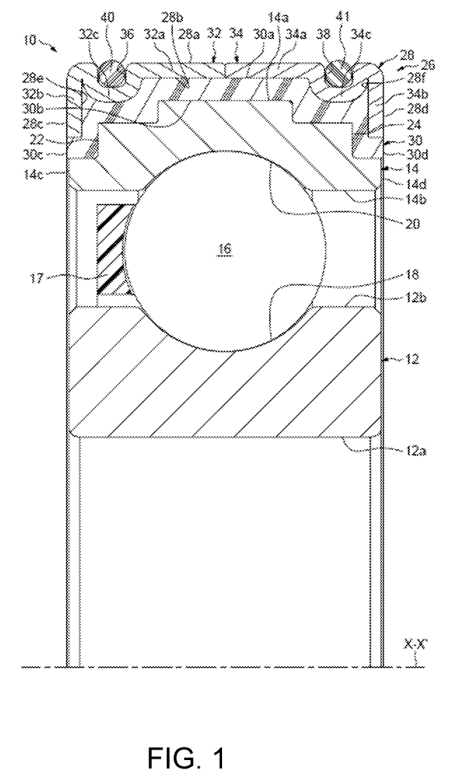

The bearing of FIG. 1 comprises a bearing 10 having a first ring 12 and a second ring 14, which are configured to rotate relative to one another around the axis X-X’ of the bearing. In the embodiment illustrated, the first ring 12 is the inner ring of the bearing 10, and the second ring 14 is the outer ring of the bearing 10.

As will be described in greater detail hereinafter, the bearing device is designed such as not to conduct electric currents. The bearing device has incorporated electrical insulation.

The inner 12 and outer 14 rings of the bearing are concentric and extend axially along the axis X-X’ of the bearing. The inner 12 and outer 14 rings are produced from steel. The rings are of the solid type. The axial direction is the direction parallel to the axis of rotation the bearing device. The radial direction is orthogonal to the axial direction and extends in a direction of a radius of the bearing device. The circumferential direction is orthogonal to the axial and radial directions.

In the embodiment illustrated, the bearing 10 also comprises a row of rolling elements 16, in this case balls, interposed radially between the inner 12 and outer 14 rings. The rolling elements 16 are produced from steel. The bearing 10 also comprises a cage 17 for maintenance of the regular circumferential spacing of the rolling elements 16. The bearing 10 can also be equipped with retainer rings or sealing flanges.

The inner ring 12 comprises a cylindrical bore 12a, a cylindrical axial outer surface 12b radially opposite the bore, and two opposite radial frontal faces (with no reference) axially delimiting the bore and the outer surface. The bore 12a and the outer surface 12b delimit the radial thickness of the inner ring 12. The bore 12a forms the inner surface of the inner ring. The inner ring 12 also includes an inner raceway 18 for the rolling elements 16, which is formed on the outer surface 12b. The raceway 18 faces radially towards the exterior.

The outer ring 14 comprises a cylindrical axial outer surface 14a, a cylindrical bore 14b radially opposite the outer surface 14a, and two opposite radial frontal faces 14c, 14d axially delimiting the bore 14b. The outer surface 14a and the bore 14b delimit the radial thickness of the outer ring 14. In the embodiment illustrated, the outer surface 14a of the ring has two distinct diameters. Alternatively, the outer surface 14a could have a single diameter. The outer ring 14 also includes an outer raceway 20 for the rolling elements 16, which is formed on the bore 14b. The raceway 20 faces radially towards the interior.

In the embodiment illustrated, a channel 22 is provided on the frontal face 14c of the outer ring. The channel 22 is oriented axially towards the exterior of the outer ring 14. The channel 22 has a base (with no reference) which is offset axially towards the interior of the ring in relation to the frontal face 14c. The base of the channel 22 forms a shoulder. In this case, the base of the channel 22 extends radially for reasons of simplicity of production. In this case, the channel 22 is annular.

Similarly, a channel 24 is provided on the frontal face 14d of the outer ring. The channel 24 is oriented axially towards the exterior of the outer ring 14. The channel 24 has a base (with no reference) which is offset axially towards the interior of the ring in relation to the frontal face 14d. The base of the channel 24 forms a shoulder. In this case, the base of the channel 24 extends radially. In this case, the channel 24 is annular. The channels 22, 24 are symmetrical in relation to one another relative to a median radial plane of the outer ring. The channels 22, 24 delimit axially the outer surface 14a. As a variant, it would be possible to provide an outer ring without channels 22, 24.

The bearing device also comprises an electrical insulation sleeve 26 fitted on the outer ring 14. The insulation sleeve 26 is fitted on the outer surface 14a of the outer ring 14. The insulation sleeve 26 is integral with the outer ring 14. The insulation sleeve 26 comprises a bushing 28 and an insulating lining 30 interposed radially between the outer ring 14 and the bushing 28. The insulating lining 30 is overmolded on the outer ring 14 and on the bushing 28.

The bushing 28 is annular. The bushing 28 is constituted by two distinct parts 32, 34. These two separate parts 32, 34 form half-flanges which in this case are axially supported against one another. In the embodiment illustrated, the parts 32, 34 of the bushing are identical and symmetrical in relation to a median radial plane of the device in order to reduce the production costs. Alternatively, it will be appreciated that it is possible to provide non-symmetrical parts 32, 34. In another variant, it could be possible for the bushing 28 to be constituted by more than two parts. Preferably, the parts 32, 34 of the bushing 28 are produced from steel. The parts 32, 34 can advantageously be obtained from a metal plate or sheet metal by cutting, stamping and rolling. Alternatively, the parts 32, 34 can be obtained from a tube or from forged and/or rolled blanks, or also by sintering and stamping.

The bushing 28 comprises an outer surface 28a, and a bore 28b radially opposite the outer surface 28a. The bore 28b forms the inner surface of the bushing 28.

Annular grooves 36, 38 are formed on the outer surface 28a of the bushing. The grooves 36, 38 are open radially in a direction away from the insulating lining 30, i.e. on the outer side. In this case, the grooves 36, 38 are formed during the production of the parts 32, 34 obtained from a metal plate or sheet metal by cutting, stamping and rolling. Alternatively, the grooves 36, 38 can be formed during the production of the parts 32, 34 obtained from a tube or from forged and/or rolled blanks, or also from sintering and stamping.

Each part 32, 34 of the bushing comprises an annular axial portion 32a, 34a, an annular radial flange 32b, 34b extending radially towards the interior, and a rounded annular connection portion 32c, 34c connecting the axial portion 32a, 34a to the radial flange 32b, 34b. The axial portions 32a, 34a are axially supported against one another. The radial flange 32b, 34b extends the end of the rounded connection portion 32c, 34c situated axially on the outer side of the device. In the embodiment illustrated, the radial flanges 32b, 34b are annular. Alternatively, at least one of the radial flanges 32b, 34b could be in the form of sectors which are spaced from one another in the circumferential direction.

The axial portions 32a, 34a of the parts of the bushing delimit the outer surface 28a, together with the rounded connection portions 32c, 34c of the bushing. Similarly, the axial portions 32a, 34a of the parts of the bushing delimit the bore 28b together with the rounded connection portions 32c, 34c of the bushing. The outer surface 28a and the bore 28b delimit the radial thickness of the bushing 28.

The rounded connection portion 32c, 34c delimits the groove 36, 38. The rounded connection portion 32c, 34c delimits the groove 36, 38 in the axial direction and in the radial direction. The rounded connection portion 32c, 34c is offset axially on the side of the insulating lining 30 in relation to the axial portion 32a, 34a. In other words, rounded connection portion 32c, 34c remains radially recessed in relation to the axial portion 32a, 34a.

The bearing device also comprises an annular retainer ring 40, which is positioned in the groove 36 delimited by the rounded connection portion 32c, and projects radially relative to the outer surface 28a of the bushing, in this case radially towards the exterior, beyond the outer diameter of the bushing 28.

The bearing device also comprises an annular retainer ring 41, which is positioned in the groove 38 delimited by the rounded connection portion 34c, and projects radially relative to the outer surface 28a of the bushing, in this case radially towards the exterior beyond the outer diameter of the bushing 28. The retainer ring 41 is in this case identical to the retainer ring 40.

The retainer rings 40, 41 are symmetrical with one another in relation to the median radial plane of the outer ring. Each retainer ring 40, 41 is an element which is distinct from the bushing 28 and the insulating lining 30. Alternatively, the bearing device could comprise a single one of the annular retainer rings 40, 41.

Each retainer ring 40, 41 delimits the outer diameter of the bearing device. The retainer ring 40, 41 is resiliently deformable. The retainer ring 40, 41 can be produced from resiliently deformable material. The retainer ring 40, 41 can for example be produced from a synthetic material such as SEBS, or from elastomer material such as silicone rubber, latex, butyl, EPDM, nitrile, a thermoplastic elastomer, etc.

As a variant, the retainer ring 40, 41 could be produced from rigid material. The retainer ring 40, 41 can for example be produced from metal material such as steel. In this case, the deformable nature of the retainer ring 40, 41 is obtained by means of its form. In this case, the retainer ring 40, 41 has a circular cross-section. Alternatively, the retainer ring 40, 41 could have another form of cross-section, such as square, rectangular, etc.

Each groove 36, 38 is delimited in the axial direction by two lateral flanks of the rounded connection portion 32c facing one another, which have a straight profile in axial cross section, and are connected to one another by an axial base. Alternatively, it is possible to provide other forms, for example grooves, which in this case have in straight cross-section a form of an arc of a circle oriented towards the exterior.

The retainer ring 40, 41 has a radial thickness which is greater than the radial depth of the groove 36, 38. In this case, the radial depth of the groove 36, 38 is measured between the outer diameter of the bushing 28 and the base of the groove 36, 38. The retainer ring 40, 41 has an axial width which is smaller than the axial width of the groove 36, 38. In this case, the axial width of the groove 36, 38 is measured between the lateral flanks of the groove 36, 38.

In the embodiment illustrated, the rounded connection portions 32c, 34c are annular, and thus extend around 360° in the circumferential direction. Alternatively, at least one of the rounded connection portions 32c, 34c could extend in the circumferential direction around an angular sector smaller than 360°. In the embodiment illustrated, the retainer ring 40, 41 is annular, and thus extends around 360° in the circumferential direction. Alternatively, the retainer ring 40, 41 could extend in the circumferential direction around an angular sector smaller than 360°.

The bushing 28 also comprises two opposite radial frontal faces 28c, 28d delimiting axially the outer surface 28a. The frontal faces 28c, 28d delimit the axial length of the bushing. The frontal face 28c is delimited by the radial flange 32b, and the frontal face 28d is delimited by the radial flange 34b. More specifically, the frontal face 28c is delimited by the outer face of the radial flange 32b, and the frontal face 28d is delimited by the outer face of the radial flange 34b.

In the embodiment illustrated, the frontal faces 28c, 28d of the bushing are respectively coplanar with the frontal faces 14c, 14d of the outer ring. Alternatively, other arrangements could be provided. For example, the bushing 28 could have an axial dimension which is smaller or larger, and remain axially recessed from the faces 14c, 14d of the outer ring, or projecting from the faces.

The bushing 28 also comprises two inner radial faces 28e, 28f, which are offset axially towards the interior of the bearing device in relation to the frontal faces 28c, 28d of the bushing, and which delimit axially the inner surface 28b. The inner radial face 28e is delimited by the radial flange 32b, and the inner radial face 28f is delimited by the radial flange 34b. More specifically, the inner radial face 28e is delimited by the inner face of the radial flange 32b, and the inner radial face 28f is delimited by the inner face of the radial flange 34b.

The retainer ring 40, 41 remains axially spaced from the radial frontal faces 28c, 28d and from the inner radial faces 28e, 28f. In the embodiment illustrated, the radial flanges 32b, 34b of the parts of the bushing extend radially beyond the outer surface 14a of the outer ring, i.e. projecting radially towards the interior in relation to the outer surface 14a. In other words, the free ends of the radial flanges 32b, 34b are offset radially inward relative to the outer surface 14a of the outer ring. The radial flanges 32b, 34b extend partly in the channels 22, 24 of the outer ring. The radial flanges 32b, 34b remain spaced from the inner ring 12.

In the embodiment illustrated, the bushing 28 is constituted by two distinct separate parts 32, 34. Alternatively, the two parts 32, 34 of the bushing could be integral, in other words they could be mono-block and form a single piece.

The insulating lining 30 is produced from electrically insulating material. For example, the insulating lining 30 can be produced from synthetic material such as a (polyether ether ketone) PEEK or a PA46, or it could also be produced from elastomer material, for example rubber.

The insulating lining 30 is interposed radially between the outer surface 14a of the outer ring and the bore 28b of the bushing. The insulating lining 30 covers the outer surface 14a of the outer ring. In this case, the insulating lining 30 covers the outer surface 14a entirely, taking into consideration the axial and circumferential directions. The insulating lining 30 also covers the grooves 22, 24 of the outer ring.

The insulating lining 30 also covers the bore 28b of the bushing. The insulating lining 30 in this case also covers the bore 28b entirely, taking into consideration the axial and circumferential directions. The insulating lining 30 covers the bore of the axial portion 32a, 34a of each part 32, 34 of the bushing, and the bore of the rounded connection portion 32c, 34c of each part 32, 34 of the bushing.

The insulating lining 30 also covers the inner radial face 28e, 28f of the radial flange 32b, 34b of each part 32, 34 of the bushing. The inner radial face 28e, 28f and the radial frontal face 28c, 28d of each radial flange 32b and 34b delimit the axial thickness of the flange. For each radial flange 32b and 34b, the inner radial face 28e, 28f is oriented axially towards the interior of the device, and the radial frontal face 28c, 28d is oriented axially towards the exterior of the device. The insulating lining 30 also covers the free end of the radial flange 32b, 34b of each part 32, 34 of the bushing.

The insulating lining 30 has an annular form. The insulating lining 30 extends axially. The insulating lining 30 comprises an outer surface 30a, a bore 30b radially opposite the outer surface 30a, and two opposite radial frontal faces 30c, 30d delimiting axially the bore 30a and the outer surface 30b. The radial frontal faces 30c, 30d delimit axially the axial length of the insulating lining 30. The outer surface 30a and the bore 30b delimit the radial thickness of the insulating lining 30. The outer surface 30a is in radial contact with the bore 28b of the bushing. The outer surface 30a is also in radial contact with the free end of the radial flange 32b, 34b of each part 32, 34 of the bushing. The outer surface 30a has a stepped form. The bore 30b is in radial contact with the outer surface 14a of the outer ring and with the channels 22, 24. The bore 30b has a stepped form.

In the embodiment illustrated, the faces 14c, 30c, 28c and 14d, 30d, 28d of the outer ring, the insulating lining and the bushing are respectively coplanar.

Alternatively, it is possible to provide other arrangements. For example, the insulating lining 30 could have a reduced axial dimension, and remain axially recessed from the faces 14c, 14d of the outer ring. Alternatively, the insulating lining 30 could have an increased axial dimension, and extend axially projecting from the faces 14c, 14d of the outer ring. In this case, the insulating lining 30 can cover these faces 14c, 14d at least partly. As a variant, the insulating lining 30 could cover the frontal faces 28c, 28d of the bushing at least partly.

In another alternative or in combination, the bushing 28 could extend axially projecting from the insulating lining 30 in relation to the faces 30c and 30d, or remain axially recessed from these faces.

The bore of the axial portion 32a, 34a of each part 32, 34 of the bushing could also be provided with an overmolding groove which extends circumferentially around the axis X-X’, and is oriented radially on the side of the outer ring 14, i.e. radially towards the interior.

In this case, the insulating lining 30 would also comprise two ribs extending radially towards the exterior from the outer surface 30a, each accommodated in the interior of one of the overmolding grooves of the bushing, and with a form complementary to the associated overmolding groove.

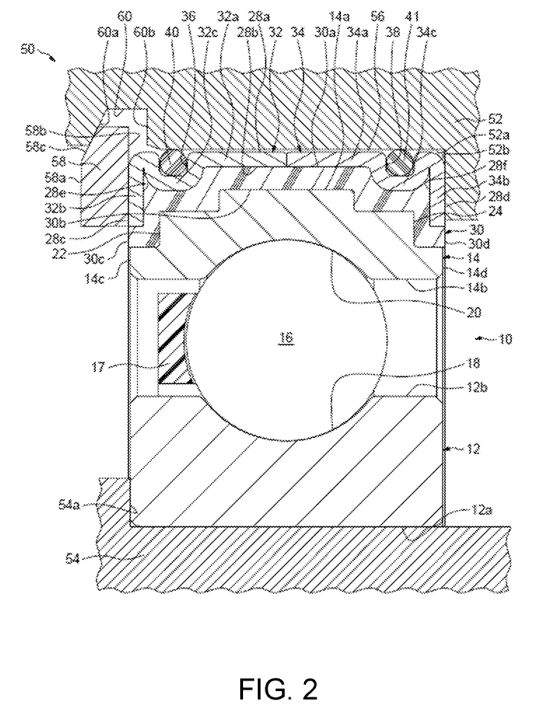

FIG. 2 illustrates an electric motor 50 comprising a fixed housing 52, a rotary shaft 54 with an axis X-X’, and the bearing device described above fitted radially between the bore 52a of the housing and the shaft 54. The bore 52a is formed by a cylindrical inner surface of the housing 52. The inner ring 12 is radially in contact with the shaft 54. A radial gap 56 exists between the bushing 28 and the bore 52a of the housing, in particular between the outer surface 28a of the bushing and the bore 52a of the housing.

The retainer ring 40, 41 is radially compressed between the base of the groove 36, 38 and the bore 52a of the housing, thus making it possible to ensure the retention in the circumferential direction of the insulation sleeve 26 and the outer ring 14 relative to the fixed housing 52, and which also ensures the retention of the bearing device in the axial direction.

The bearing device is interposed axially between a shoulder 52b of the housing, which is axially in contact with the radial flange 34b, and a shoulder 54a of the rotary shaft which is axially in contact with the inner ring 12. An open axial retention ring 58 is inserted partly in an annular channel 60 which is formed on the inner surface of the housing 52. The open axial retention ring 58 is axially in contact with the radial flange 32b.

The annular channel 60 is delimited in the axial direction by two lateral flanks 60a, 60b, which are connected to one another by an axial base. The lateral flank 60a which is situated axially spaced from the bearing device is inclined in relation to the radial direction. The opposite lateral flank 60b is situated axially between the radial frontal faces 28c, 28d, and extends purely radially.

The open axial retention ring 58 is delimited in the axial direction by two lateral faces 58a, 58b. The face 58a which is opposite the bearing device is beveled, with the bevel 58c of the face 58a being in contact with the lateral flank 60a of the annular groove which is inclined.

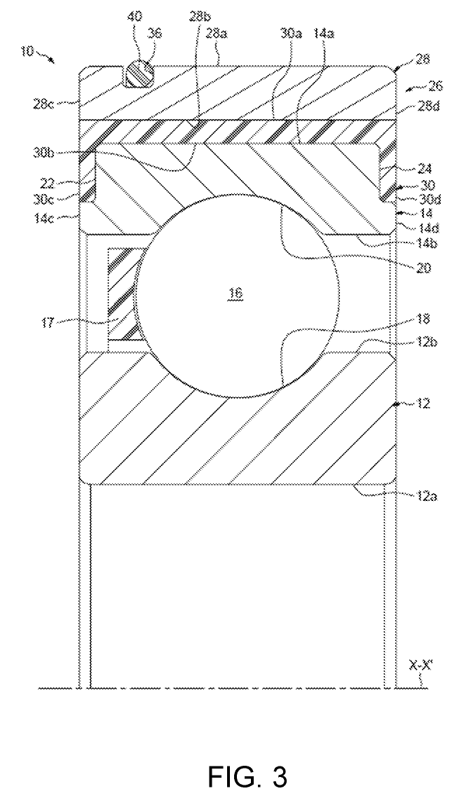

The embodiment illustrated in FIG. 3 differs from the embodiment illustrated in FIG. 1 in the production of the bushing 28, which in this case is mono-block, that is, as one piece. The bushing 28 has an annular form. Preferably, the bushing 28 is produced from steel. The bushing 28 is of the solid type. The bushing 28 comprises an outer surface 28a, and a bore 28b radially opposite the outer surface 28a. The bore 28b forms the inner surface of the bushing 28. The outer surface 28a and the bore 28b delimit the radial thickness of the bushing 28.

A groove 36 is formed, in particular machined, on the outer surface 28a of the bushing. The groove 36 is delimited in the axial direction by two lateral flanks facing one another, which in axial cross-section have a straight profile, and are connected to one another by an axial base. Alternatively, it is possible to provide other forms, for example grooves which in this case in straight cross-section have the form of an arc of a circle oriented towards the exterior.

The bushing 28 is in this case without symmetry in relation to a median radial plane of the device, in order to reduce the production costs. Alternatively, the bushing 28 could be symmetrical in relation to a median radial plane of the device. For example, the groove 36 could be centered on the median radial plane of the device, or the bushing 28 could comprise a plurality of grooves 36.

The bearing device also comprises the annular retainer ring 40, which is resiliently deformable, positioned in the groove 36, and extends radially projecting in relation to the outer surface 28a of the bushing, and in this case radially towards the exterior, beyond the outer diameter of the bushing 28. The retainer ring 40 is an element distinct from the bushing 28 and the insulating lining 30. The retainer ring 40 delimits the outer diameter of the bearing device. The retainer ring 40 is resiliently deformable.

The retainer ring 40 can be produced from resiliently deformable material. The retainer ring 40 can for example be produced from a synthetic material such as SEBS, or from elastomer material such as silicon rubber, latex, butyl, EPDM, nitrile, a thermoplastic elastomer, etc. As a variant, the retainer ring 40 could be produced from rigid material. The retainer ring 40 can for example be produced from metal material such as steel. In this case, the deformable nature of the retainer ring 40 is obtained by means of its form.

In this case, the retainer ring 40 has a circular cross-section. Alternatively, the retainer ring 40 could have another form of cross-section, such as square, rectangular, etc. The retainer ring 40 has a radial thickness greater than the radial depth of the groove 36. The radial depth of the groove 36 is in this case measured between the outer diameter of the bushing 28 and the base of the groove 36. The retainer ring 40 has an axial width smaller than the axial width of the groove 36. The axial width of the groove 36 is in this case measured between the lateral flanks of the groove 36.

The bushing 28 also comprises two opposite radial frontal faces 28c, 28d, delimiting axially the outer 28a and the inner 28b surface. The frontal faces 28c, 28d delimit the axial length of the bushing. The retainer ring 40 remains axially spaced from the frontal faces 28c, 28d.

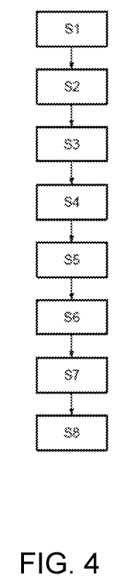

FIG. 4 illustrates schematically a method for production of the bearing device according to the first embodiment illustrated in FIG. 1.

The starting point is a step S1 of fitting of the first part 32 of the bushing in the interior of a mold which is designed for the overmolding of the insulating lining 30. For the production of the bearing device according to the second embodiment illustrated in FIG. 3, the step S1 comprises fitting of the bushing 28 in the interior of the mold which is designed for the overmolding of the insulating lining 30. Then, a step S2 is carried out of putting the outer ring 14 in the interior of the production mold.

A step S3 is then carried out, of fitting of the second part 34 of the bushing and the interior of the production mold, axially supported against the first part 32 of the bushing. In this position fitted in the interior of the mold, the bushing 28 is radially spaced from the outer ring 14, and, in this case, the first and second parts 32, 34 of the bushing are radially spaced from the outer ring 14. For the production of the bearing device according to the second embodiment illustrated in FIG. 3, the step S3 is not carried out since the bushing 28 is mono-block.

Then, a step S4 is carried out of overmolding of the insulating lining 36. The insulating lining 30 is overmolded both on the outer ring 14 and on the inner surface 28b of the bushing. In particular, the insulating lining 30 is overmolded both on the outer ring 14 and on the first and second parts 32, 34 of the bushing 28.

A step S5 is then carried out of extraction from the mold of the unitary assembly formed by the outer ring 14, by the first and second parts 32, 34 of the bushing, and by the insulating lining 30.

Then, a step S6 is carried out of rectification of the frontal faces 14c, 14d and of the faces 28c, 28d of the bushing. Taking into account the presence of the flanges 32b and 34b of the bushing, the rectification operation is carried out mainly on the bushing 28 and the outer ring 14, and not on the insulating lining 30. During this step, the outer surface 28a of the bushing and the raceway 20 of the outer ring can also be rectified.

A step S7 is then carried out of assembly of the unitary assembly formed by the outer ring 14, by the first and second parts 32, 34 of the bushing, and by the insulating lining 30, with the row of rolling elements 16, the cage 17 and the inner ring 12.

Finally, a step S8 is carried out of assembly of the retainer ring 40 with the assembly formed by the outer ring 14, by the first and second parts 32, 34 of the bushing, by the insulating lining 30, by the row of rolling elements 16, by the cage 17 and by the inner ring 12.

In the embodiments illustrated, the first ring 12 of the bearing is the inner ring, and the second ring 14, on which the insulating lining 30 is overmolded, is the outer ring.

Alternatively, it is possible to provide an inverted arrangement in which the second ring 14, on which the insulating lining 30 is overmolded, is the inner ring. In this case, the insulation sleeve is situated in the bore 12a of the inner ring. The insulating lining is then interposed radially between the bore 12a of the inner ring and the outer surface of the bushing. The insulating lining is overmolded on the inner ring and at least on the outer surface of the bushing. The bore of the bushing delimits the bore of the bearing device. In this case, the groove(s) 36, 38 is/are open radially on the side opposite the insulating lining 30, i.e. on the inner side. The retainer ring 40, 41 is positioned in the associated groove 36, 38, and delimits the inner diameter of the bearing device. The retainer ring 40, 41 is radially compressed between the base of the groove 36, 38 and the shaft 54, thus making it possible to ensure the retention in the circumferential direction of the insulation sleeve 26 and the inner ring 12, relative to the shaft 54, and the retention in the axial direction of the bearing device.

In the embodiments described, the bearing device is provided with a single row of rolling elements. As a variant, the bearing can be provided with a plurality of rows of rolling elements. In addition, the roller bearing can comprise types of rolling elements other than balls, for example rollers. In another variant, the bearing can be a slide bearing without rolling elements.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved insulated bearing devices.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

What is claimed is:

1. A bearing device comprising:
a bearing comprising a first ring and a second ring configured for relative rotation, and an insulation sleeve mounted on the second ring, the insulation sleeve comprising a bushing and an electrically insulating lining interposed radially between the bushing and the second ring,
wherein the bushing has an outer surface and an inner surface opposite the outer surface which delimit a radial thickness of the bushing,
wherein the insulating lining is overmolded on the second ring and the bushing,
wherein at least one groove is provided on a surface of the bushing facing away from the insulating liner and a resiliently deformable respective retainer ring is mounted in each of the at least one groove, and
wherein a portion of each of the at least one retainer ring projects from the at least one groove radially beyond the surface of the bushing facing away from the insulating liner.

2. The device according to claim 1,
wherein the bushing is axially delimited by a first radially extending face and a second radially extending face, and
wherein the retainer ring axially spaced from the first and second radially extending faces.

3. The device according to claim 2,
wherein a radial thickness of each of the at least one retainer ring is greater than a radial depth of each of the at least one groove.

4. The device according to claim 3,
wherein an axial width of the at least one retainer ring is less than an axial width of the at least one groove.

5. The device according to claim 4,
wherein the at least one groove is annular.

6. The device according to claim 5,
wherein the at least one retainer ring is annular.

7. The device according to claim 6,
wherein the bushing is mono-block.

8. The device according to claim 6,
wherein the bushing is produced from at least a first part and a second part,
wherein each of the parts includes an axial portion,
wherein the axial portion of the first part abuts the axial part of the second part at a joint, and
wherein axial portion of the first part and the axial portion of the second part jointly
delimit at least partly a surface of the bushing on which the insulating lining is overmolded.

9. The device according to claim 1,
wherein the second ring is a radially outer ring and the at least one groove faces radially outward.

10. The device according to claim 9,
wherein the at least one groove comprises exactly two grooves.

11. The device according to claim 9,
wherein the at least one groove comprises no more than one groove.

12. The device according to claim 9,
wherein the at least one retainer ring is formed from steel.

13. The device according to claim 9,
wherein the retainer ring is formed from Styrene-Ethylene-Butylene-Styrene.

14. An electric motor comprising:
a housing having a bore,
a shaft, and
at least one bearing device according claim 1 fitted radially between the bore of the housing and the shaft.

15. A method for production of a bearing device comprising:
fitting a bushing at a base of a production mold;
putting a first bearing ring into an interior of the production mold;
overmolding an insulating lining at least on the ring and the bushing to form a unitary assembly,
extracting the unitary assembly from the mold,
assembling the unitary assembly with a second bearing ring second ring, and
placing a retainer ring into a circumferential groove of the bushing.
